(19) United States
(12) Patent Application Publication
(10) Pub. No.: US 2011/0258061 A1
(43) Pub. Date: Oct. 20, 2011

(54) Systems and Methods for Self-Service Transactions

(76) Inventor: Timothy A. McLean, Estevan (CA)

(21) Appl. No.: 12/763,342

(22) Filed: Apr. 20, 2010

(51) Int. Cl. G06Q 30/00

(52) U.S. Cl. 705/26.1

(57) ABSTRACT

A self-service terminal for a product/service cooperates with an application platform accessible by a consumer's mobile device. The terminal assigns an active status to at least one transaction code for a period of time and compares any code manually entered at the terminal during that time against the active code(s) to dispense the product/service in case of a match. In response to a request from the mobile device, an authorized code is sent from the platform to the mobile device to enable the consumer's manual entry of the authorized code at the terminal. The platform may generate the authorized code and forwarded it to the terminal for storage as an active code, or may select it from among codes that are stored on the platform and known to match codes currently in an active state at the terminal based on a predetermined schedule for activating different groups of codes

### FIELD OF THE INVENTION

The present invention relates generally to purchasing of a product or service from a self-service terminal, and more particularly to the purchase of a service or product from such a terminal using a mobile communications device.

### BACKGROUND OF THE INVENTION

There have been a number of proposals made in prior art patents to enable consumers to use cellular phones or other mobile communications devices to authorize the purchase of items from vending machines without having to carry cash (coins or paper notes), credit cards or smart cards. Examples of such systems of methods can be found in U.S. Pat. No. 6,584,309 of Whig ham, U.S. Pat. No. 6,647,256 of Stewen et al, U.S. Pat. No. 6,764,003 of Martschitsch et al., U.S. Pat. No. 7,110,954 of Yung et al., and U.S. Pat. No. 7,574,377 of Carapelli et al., U.S. Patent Application Publication 2008/0154735 of Carlson and PCT Publication WO2007/015610, each of which is incorporated herein by reference.

However, Applicant of the present invention has developed a unique solution for vending machine or other self-service terminal transactions that improves on the prior art by incorporating unique aspects into the novel method and system that aid in ensuring that the product or service provided by the machine or terminal is being used by the particular consumer who requested that product or service using their mobile device.

### SUMMARY OF THE INVENTION

According to a first aspect of the invention there is provided a system for facilitating a self-service transaction by a consumer having a mobile communications device in order to obtain a product or service, the system comprising:

a self-service terminal comprising:
an output device operable to provide the product or service;
a control arrangement operable to control the output device; and
a manual input device operable by the consumer to enter a code readable by the control arrangement;

an application platform accessible by the mobile communications device of the consumer to receive a product or service request from the consumer, the application platform being arranged to forward an authorized transaction code to the mobile communications device of the consumer to enable the consumer to enter the authorized transaction code to the self-service terminal using the manual input device;

wherein the control arrangement is operable to assign an active status to at least one transaction code for a period of time, compare any code entered on the manual input device during said period of time against the at least one transaction code assigned the active status, and, in response to a successful matching of the code entered on the manual input device to a respective transaction code assigned the active status, activate the output device and remove the active status of the respective transaction code.

In one embodiment, the self-service terminal comprises a communications device operable to connect to a communications network, and the application platform is arranged to also forward the authorized transaction code to the communications device of the self-service terminal and the control arrangement is arranged to assign the active status to each authorized transaction code received by the communications device of the self-service terminal for a respective period of time.

Preferably the control arrangement is operable to store multiple authorized transaction codes for respective periods of time and to check any code entered at the manual input device during an overlap of said respective periods of time against the multiple transaction codes.

In an alternate embodiment, the control arrangement may store a plurality of transaction codes and be arranged to assign the active status to different groups of said transactions codes at different periods of time, the application platform storing the same plurality of transaction codes in association with data on the periods of time for which said different groups of said transaction codes are assigned the active status at the remote terminal, the application platform being arranged to forward an active code whose period of time is not about to expire to the mobile communications device of the consumer to enable the consumer to enter the active code to the self-service terminal using the manual input device.

Preferably the application platform is arranged to receive the product or service request in the form of a text message.

Preferably the application platform is arranged to forward the authorized transaction code in a text message.

The self-service terminal may comprise a vending machine containing the product to be made accessible to the consumer by activation of the output device.

The vending machine preferably contains a plurality of different selectable products and the input device, after the successful matching of the code entered thereon, is operable to select a particular product to which access by the consumer is then provided by activation of the output device.

Alternatively, the self-service terminal may comprise an access control terminal and the output device is operable to open a movable access barrier.

In a further alternative, the self-service terminal is a money dispensing terminal.

Preferably the application platform is remote from the self-service terminal.

Preferably there are provided multiple ones of the self-service terminal at respective locations distinct from one another, wherein the application platform is arranged to recognize a terminal ID within the product or service request from the consumer to identify a respective one of the multiple self-service terminals at which the consumer will enter the authorized transaction code.

Preferably the self service terminal comprises output confirmation equipment operable to confirm that the service or product has been provided and, in response thereto, provide a transaction confirmation to the application platform to authorize billing of the consumer.

According to a second aspect of the invention there is provided a method of facilitating a self-service transaction by a consumer having a mobile communications device in order to obtain a product or service, the method comprising:

at an application platform:
receiving a product or service request from a mobile communications device of the consumer; and
forwarding an authorized transaction code to the mobile communications device of the consumer to enable the consumer to enter the authorized transaction code to the self-service terminal using a manual input device thereof; and

at the self-service terminal:
assigning an active status to at least one transaction code for a period of time;
in response to entry of any code to the self-service terminal using the manual input mechanism thereof during the period of time, comparing the code entered on the manual input mechanism against the at least one transaction code assigned the active status; and
in response to a successfully matching of the code entered on the manual input mechanism to a respective transaction code assigned the active status, activating an output device of the remote terminal to provide the product or service to the consumer and removing the active status of the respective transaction code.

In one embodiment, the method includes forwarding the authorized transaction code from the application platform to the self-service terminal and, at the self-service terminal, assigning the active status to the authorized transaction code for a respective period of time. Preferably this embodiment includes generating the authorized transaction code at the application platform.

In an alternate embodiment, the method includes storing a same plurality of transaction codes at the application platform and at the self-service terminal along with data on different periods of time for which the active status is to be assigned to different groups of said transaction codes, assigning the active status to the different groups of said transaction codes at the self-service terminal according to the different periods of time, selecting a respective active code whose period of time is not about to expire from the application platform in response to the product or service request, and forwarding the respective active code to the mobile communications device of the consumer to enable the consumer to enter the respective active code to the self-service terminal using the manual input device.

Preferably the method further comprises confirming at the self-service terminal that the product or service has been provided and, in response thereto, signaling the application platform of a successful transaction to authorize billing of the consumer.

According to a third aspect of the invention there is provided a system for facilitating a self-service transaction by a consumer having a mobile communications device in order to obtain a product or service, the system comprising:

a self-service terminal comprising:
an output device operable to provide the product or service;
a communications device operable to connect to a communications network;
a control arrangement operable to control the output device; and
a manual input device operable by the consumer to enter a code readable by the control arrangement;

an application platform accessible by the mobile communications device of the consumer to receive a product or service request from the consumer, the application platform being arranged to forward an authorized transaction code to the communications device of the self-service terminal and the mobile communications device of the consumer to enable the consumer to enter the authorized transaction code to the self-service terminal using the manual input device;

wherein the control arrangement is operable to store the authorized transaction code for a period of time and compare any code entered on the manual input device during said period of time against the authorized transaction code to activate the output device if the code entered on the manual input device matches the authorized transaction code.

According to a fourth aspect of the invention there is provided a system for facilitating a self-service transaction by a consumer having a mobile communications device in order to obtain a product or service, the system comprising:

a self-service terminal comprising:
an output device operable to provide the product or service;
a control arrangement operable to control the output device, store a plurality of transaction codes and assign different groups of said transaction codes an active status at different periods of time; and
a manual input device operable by the consumer to enter a code readable by the control arrangement; and
an application platform accessible by the mobile communications device of the consumer to receive a product or service request from the consumer, the application platform storing the same plurality of transaction codes as the control arrangement in association with data on the periods of time at which said different groups of said transaction codes are assigned the active status at the self-service terminal, the application platform being arranged to forward an active code whose period of time is not about to expire to the mobile communications device of the consumer to enable the consumer to enter the forwarded active code to the self-service terminal using the manual input device;

the control arrangement being operable to compare any code entered at the manual input device during a respective period of time against the transaction codes assigned the active status for said respective period of time and, when the code entered at the manual input device matches any one of said transaction codes assigned the active status for said respective period of time, activate the output device and remove the active status from the transaction code matching that entered at the manual input device.

### BRIEF DESCRIPTION OF THE DRAWINGS

In the accompanying drawings, which illustrate an exemplary embodiment of the present invention:

FIG. 1 is a schematic diagram of a system for dispensing a product from a vending machine in a transaction initiated by a text-message product request sent by a consumer through the short message service (SMS) using a mobile communications device.

FIG. 2 is a schematic diagram of the vending machine from the system of FIG. 1.

FIG. 3 is another schematic diagram of the vending machine from the system of FIG. 1.

### DETAILED DESCRIPTION

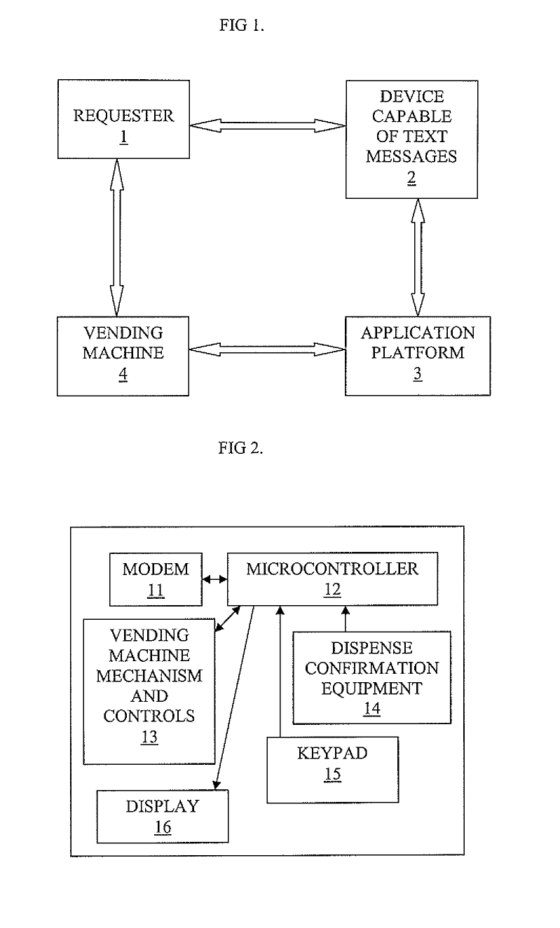

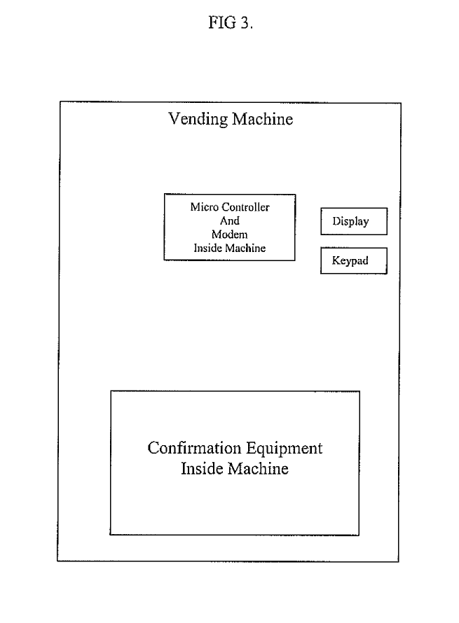

With reference to FIGS. 1 and 2, in the illustrated embodiments of the invention, a user 1 sends a text message on a consumer 2 device such as a cellular phone or any other mobile communications device capable of sending a text message. This message is sent to a premium rate number, which may be a short code, long code, or tolled number. The message contains a request for a purchase or transaction code for a specific Vending machine 4 or access gate or any other self-service device 4 or terminal, which may dispense product or monies or provide access to something or information. In the following detailed description of preferred embodiments, such a self-service terminal is frequently referred to as a vending machine or gate from this point on.

The text message is received by a central system or application platform featuring an appropriate combination of hardware and software required to perform the functions described herein, the requirements of which will be readily appreciated by those of skill in the art. This central system or application platform may be provided by a connection aggregator (a company which interacts with telephone carriers for short code use), which checks to see if the message is valid. That is, the application platform (AP) 3 checks to see whether the text message matches a predefined format that is to be recognized as a product or service request from a consumer. If the message does not match the expected request message format, the message is not considered valid, the application platform (AP) 3 responds to the requester 1 with an “invalid request” message. If the message is valid, the central system AP 3 extracts a unique Vending machine ID or Gate ID from the message, which was entered by the requester as all or part of their request message based on an instructional display on the vending machine or gate that informed them of the text message content to send to initiate a transaction with the machine or gate and the number to send the text message to. For example, a printed or electronic display on the vending machine may present a 3-digit ID and a 5 or 6 digit short code number to which the ID number is to be sent by a SMS text message to initiate a vending transaction, the 3-digit ID being unique among the IDs of any other machines in the same system. The number of digits of the ID may be varied and the digit-length of operable short code numbers are known to vary in different regions, and it will accordingly be appreciated that the 3 and 5 or 6 digit lengths of these numbers are presented as examples only.

The ID extracted from the valid request message tells the Application Platform 3 which Vending machine or Gate 4 the request is for. In an embodiment in which only one Vending Machine or Gate 4 interacts with the AP 3, the ID check prevents initiation of a transaction procedure at the Vending Machine or Gate by messages inadvertently sent to the AP 3 by someone dialing a wrong-number on their mobile messaging device, as the format of the incoming message would not typically match the expected message or ID format. In embodiments in which multiple Vending Machines or Gates 4 interact with the AP 3, the ID check further confirms which of the machines or gates a consumer is attempting to interact with. If the ID check is successful, the AP 3 generates a random alphanumeric code and responds to the user with this alphanumeric code, and possibly information on how to cancel the request, for example by ______. In unison to this, the AP 3 also sends the same alphanumeric code to the Vending machine 4 or Gate 4 specified in the original request message. The alphanumeric code may be of a predetermined structure, such as a four digit or number, the digit-length of which is again presented only as an example and is not intended as a limiting description of the possible code structures that may be used.

The Vending Machine or Gate 4 contains a cellular modem 11 capable of receiving text messages. A micro controller 12 continuously interrogates the cellular modem 11. When a text message is received, the micro controller (MC) 12 compares the number of the sender of the incoming message with a list of one or more acceptable numbers to confirm that the message originated from the AP 3. Like the AP, the MC compares the content of the incoming message against an expected predetermined message format to check that the incoming message is valid. If the message from the AP is valid, the MC 12 extracts the alphanumeric code, which may or may not be encrypted. The alphanumeric code is then stored in the MC memory and a time-to-live timer, which is slightly shorter than a respective time-to-live timer at the AP, is started. The Vending machine or Gate 4 is able to receive and store more alphanumeric codes, each with a separate time-to-live timer. Until the respective time-to-live timer monitored by the MC 12 expires, each alphanumeric code stored in the MC memory is considered to have an active status.

On the front of the Vending machine or gate 4, there is a keypad 15 and a display 16, which shows the alphanumeric code as it is being entered on the keypad 15, and may also be configured to display other information at other times. After the alphanumeric code has been entered, the MC compares it to all active codes (codes for which the respective time-to live-timers have not yet expired) stored in memory. If the entered code is confirmed as valid by successfully matching to an active code in memory, at this time the user can cancel the code entered by pushing a cancel button on the keypad 15. If such cancellation is requested, the MC 12 would then send a text message to the AP 3 informing the AP 3 that that code is no longer valid. The AP 3 would then text message the requester 1 that their alphanumeric code is no longer valid.

In the case of a Vending Machine containing different products from which the consumer can select, if the code entered on the key pad matches an active code in the MC memory, and thus is confirmed as a valid authorized code issued by the AP 3, then the MC 12 starts a timer, which limits the amount of time a user 1 can take to make a selection from among the multiple products. The vending machine may be configured so that the product selection is made using the same keypad that was used to enter the alphanumeric transaction code. If that timer marking the available period for product selection expires, the code becomes void and the MC 12 sends a text message to the AP 3, and the AP 3 sends a text message to the requester 1 informing them that their alphanumeric code is no longer valid. In regards to the Vending machine 4, if the requester has made a selection before the selection timer expires, the Vending machine 4 initiates the dispensing of the selected product. In the case of an access gate, for which the sole available service option or output is to move a barrier from out a closed position blocking an access-way to allow the consumer to pass therethrough before the barrier returns to its default closed position across the access-way, the selection timer may be omitted and the output device can accordingly be actuated by the consumer by the mere entry of an authorized transaction code matching an active code in the MC memory.

In the case of a Vending Machine, the MC 12 monitors the dispensing operation by use of the limit switches on the mechanical apparatus 13 that physically does the vending of the product to a part of the machine accessible by the consumer to retrieve the product. After the Vending machine 4 has tried to dispense the product, the strategically placed contact or limit switches 14 or other monitoring equipment such as infrared disruption equipment, vibration sensors or radio frequency identification tags (RFID) confirm that product was actually physically dispensed. This equipment is referred to below as confirmation equipment 14. Known arrangements and techniques for sensing successful dispensing of a vending machine product may be used, and so further details are not provided herein. A timer is started when the Vending machine 4 first tries to dispense the product, or shortly therebefore or thereafter. If the timer expires before the confirmation equipment 14 confirms that actual physical product was dispensed, then the MC 12 can send a message to the AP 3 informing it not to charge the requester 1, as product was probably not dispensed to the consumer. In this situation the MC 12 could instead try to dispense the requested product and restart the timer in question again. This repeated dispense attempt could be done a preset amount of times.

If the confirmation equipment 14 confirmed the physical dispensing of product, the MC 12 would then transmit a text message to the AP 3 informing it of the completed transaction. The AP 3 would then send the requester 1 a text message informing them of the completed transaction and confirming a charge to the account of their text-messaging device. The telephone carriers carry out this charge. In some embodiments an aggregator operates the AP and sets up the system in way to ensure that vending machine customers using their mobile devices to initiate a transaction are only billed for a successful transaction. The initial request message from the user to the AP is not billed, nor is the message containing the code to the user. The only message that is billed is the message from the AP to the user after the AP has received confirmation of a successful transaction from the vending machine. The carriers bill the users for this, and then they pay the aggregator. The aggregator accordingly pays the vending machine operator. In some embodiments set up for simplicity, every item or service that can be purchased from any of the vending machines associated with the AP is the same price, and accordingly a single premium rate number of shortcode can be used to handle all requests regardless of the specific product or service desired by a particular customer. Other embodiments may be able to accommodate differently priced products or services by using multiple numbers or shortcodes, each at a different rate. In such a system, any vending machine or gate having multiple differently-priced options would accordingly have label or display features set up to show customer's which number or shortcode to use for transactions having different dollar amounts.

As mentioned above, the AP 3 started a respective time-to-live timer for each code that it transmitted. If that time-to-live timer on the AP 3 expired before the AP 3 gets a reply back from the Vending Machine or Gate 4, then the AP 3 sends a message to the requester 1 that the alphanumeric code that they had received is no longer valid. It will be appreciated that an access gate may similarly have confirmation switches or sensing equipment operable to confirm when the requested opening the access barrier has taken place, when the re-closing of the barrier has taken place after being successfully opened to allow passage of the requesting consumer thereby, or when the requesting consumer has passed through the access-way. Money dispensing terminals can be similarly equipped to confirm successful dispensing, and information display terminals using electronic displays can also send signals back to the AP to confirm the that the requested information has been displayed.

In another embodiment of the Invention, the communication path between the AP 3 and the gate or Vending machine or gate 4 could be hardwired through the telephone grid, or could be Ethernet, serial, or some other communication protocol, wired or wireless, instead of using a cellular communications network.

In another embodiment of the invention, the Vending machine or gate 4 could contain all codes pre-stored or pre-loaded within memory and never need to receive new or replacement codes, except possibly during scheduled or intermittent maintenance of equipment. Different codes within memory would become valid on a time schedule. In one example, one group of codes would become active or valid in the morning and any unused codes from that group would expire or deactivate that evening, at which time a different groups of codes would become active. This could instead happen on an hourly, semi hourly, or even on a minute-by-minute basis. In this embodiment the AP would activate and deactivate the same groups of codes on the same preset time schedule, or one slightly shorter or offset in time therefrom to account for time delay between the selection of an active code at the AP in response to a consumer request message and the receipt of the selected active code by the consumer on their mobile device and subsequently manual entry of the active code to the Vending Machine or Gate. The requester would request a transaction code for a product or service in the same manner as before and would receive an authorized alphanumeric code from the AP 3. There would not be any messages sent to the Vending Machine 4 or gate 4 in this embodiment. The Vending machine 4 or gate 4 would operate as previously mentioned except that there would be no time-to-live timer in MC 12 for the alphanumeric code. When the requester 1 entered the code into the keypad 15, the requester 1 would have a preset amount of time to make a selection and the product would have a preset amount of time to dispense. The MC 12 would then send a confirmed dispense of product message to the AP 3, in which the AP 3 would then send a message to the user confirming that they have been charged. If the AP is set up for multiple vending machines or gates, the AP stores multiple sets of code/schedule pairings for each machine or gate, which may feature different code groups for each machine.

In such an embodiment where the codes are pre-programmed into the vending machine for a time-based activation schedule to avoid the need for communication directly between the AP and the vending machine or gate during the transaction, the active time period for the different codes at the vending machine or gate may overlap by an amount of time corresponding length of the product/service selection timer of the vending machine or gate. The code group at the AP and the matching respective code group at the vending machine or gate would activate at the same time, but the switch of the active codes at the AP would switch from this first code group to the next when the second vending machine code group activates before the expiry of the vending machine's first code group. That is, each AP code group would activate at the same time as the matching code group at the vending machine, but would deactivate at the activation of the next vending machine code group. As a result, any active code issued by the AP will still be active at the vending machine for at least as long as the vending machine's selection timer value. Accordingly, for each active code at the vending machine, the matching code at the AP is issuable from a time at which the code became active at the vending machine (T_{AV}) to a point in time calculated as the deactivation time of that code at the vending machine (T_{DV}) minus the countdown value of the vending machine's selection timer (V_{ST}). A group of codes is therefore considered active from active from time T_{AV} to time T_{DV}, activate and issuable from time T_{AV} to time T_{DV}−V_{ST}, and inactive at all other times. Each code thus goes from being inactive, to being active and issuable, to being active only, and then back to inactive (expired). Overlapping the active period of every two sequentially adjacent groups of codes so that the second group activates at the first group's T_{DV}−V_{ST} ensures that any code issued by the AP during the first group's T_{DV}−V_{ST} has already been activated at the machine.

In another embodiment of this invention, the MC 12 would not need to send a message back to the AP 3 in the event of a cancelled code or failed dispensing of product. The AP's time-to-live timer for that code would expire without receiving a confirmed dispense message from the Vending Machine and the requester would get a message informing them that their code is no longer valid. In another embodiment, the AP 3 may not rely on a dispensing confirmation from the vending machine at all, which may altogether eliminate the need for any outgoing communication functionality at the vending machine. In the scheduled code switching embodiment where different groups of codes are activated at different times at the vending machine and the selectable codes at the AP are accordingly switched on a corresponding schedule, a lack of dispensing confirmation may eliminate the need for any network connected or connectable communications device at the vending machine at all, unless such a device is for example being employed to send out data on product stock levels within the machine to an owner, operator or maintainer of the machine, as is known from the prior art and may be employed in machines using the transaction-code dispensing authorization techniques of the present invention.

By requiring the consumer to enter an authorized transaction code on the manually operated keypad of the vending machine or gate, the present invention better ensures that the person obtaining the requested product or service is in fact the person that requested it with their mobile device. Accordingly, users of the above embodiments need not worry about the potential in a crowded environment, or in a moment of distraction, that another party dispenses and makes off with a product based on the transaction being billed to the requester, as the correct authorization code must be entered before the product can be dispensed. Accordingly, the requester need not necessarily stand immediately in front of the machine and block the view thereof from others when placing their request on their mobile device, as they do not need to safeguard the machine from others.

Also, with the above embodiments, the order in which consumers retrieve their product or access their service relative to the order in which they sent their request messages is not significant, as the use of the transaction codes to authorize or confirm the identify of the dispensing party as the requesting consumer ties each transaction to the correct requester. Even where the terminal provides only has a single product or service to offer or has multiple options of equal cost, this is a notable feature as it may prevent a consumer from being charged for an unsuccessful transaction. That is, if no transaction code was used to tie an individual requester to a particular transaction, two consumers who place requests at approximately the same time, only to have the machine successfully dispense only one of two requested products, may find that the user who's mobile device account is being billed was the one who did not successfully obtain the desired product. The above embodiments avoid this complication and any potential dispute that may arise therefrom.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A system for facilitating a self-service transaction by a consumer having a mobile communications device in order to obtain a product or service, the system comprising:
a self-service terminal comprising:
an output device operable to provide the product or service;
a control arrangement operable to control the output device; and
a manual input device operable by the consumer to enter a code readable by the control arrangement;
an application platform accessible by the mobile communications device of the consumer to receive a product or service request from the consumer, the application platform being arranged to forward an authorized transaction code to the mobile communications device of the consumer to enable the consumer to enter the authorized transaction code to the self-service terminal using the manual input device;
wherein the control arrangement is operable to assign an active status to at least one transaction code for a period of time, compare any code entered on the manual input device during said period of time against the at least one transaction code assigned the active status, and, in response to a successful matching of the code entered on the manual input device to a respective transaction code assigned the active status, activate the output device and remove the active status of the respective transaction code.

2. The system of claim 1 wherein the self-service terminal comprises a communications device operable to connect to a communications network, the application platform is arranged to also forward the authorized transaction code to the communications device of the self-service terminal and the control arrangement is arranged to assign the active status to each authorized transaction code received by the communications device of the self-service terminal for a respective period of time.

3. The system of claim 1 wherein the control arrangement stores a plurality of transaction codes and is arranged to assign the active status to different groups of said transactions codes at different periods of time, and the application platform stores the same plurality of transaction codes in association with data on the periods of time for which said different groups of said transaction codes are assigned the active status at the remote terminal, the application platform being arranged to forward an active code whose period of time is not about to expire to the mobile communications device of the consumer to enable the consumer to enter the active code to the self-service terminal using the manual input device.

4. The system of claim 1 wherein the application platform is arranged to receive the product or service request in the form of a text message.

5. The system of claims 1 wherein the application platform is arranged to forward the authorized transaction code to the mobile communications device of the consumer in a text message.

6. The system of claim 2 wherein the application platform is arranged to forward the authorized transaction code to at least one of the mobile communications device of the consumer and the communications device of the self-service terminal in a respective text message.

7. The system of claim 2 wherein the control arrangement is operable to store multiple authorized transaction codes for respective periods of time and to check any code entered at the manual input device during an overlap of said respective periods of time against the multiple transaction codes.

8. The system of claim 1 wherein the self-service terminal comprises a vending machine containing the product to be made accessible to the consumer by activation of the output device.

9. The system of claim 8 wherein the vending machine contains a plurality of different selectable products and the input device, after the successful matching of the code entered thereon, is operable to select a particular product to which access by the consumer is then provided by activation of the output device.

10. The system of claim 1 wherein the self-service terminal comprises an access control terminal and the output device is operable to open a movable access barrier.

11. The system of claim 1 wherein the self-service terminal comprises a money dispensing terminal.

12. The system of claim 1 wherein the application platform is remote from the self-service terminal.

13. The system of claim 1 comprising multiple ones of the self-service terminal at respective locations distinct from one another, wherein the application platform is arranged to recognize a terminal ID within the product or service request from the consumer to identify a respective one of the multiple self-service terminals at which the consumer will enter the authorized transaction code.

14. The system of claim 1 wherein the self service terminal comprises output confirmation equipment operable to confirm that the service or product has been provided and, in response thereto, provide a transaction confirmation to the application platform to authorize billing of the consumer.

15. A Method of facilitating a self-service transaction by a consumer having a mobile communications device in order to obtain a product or service, the method comprising:
at an application platform:
receiving a product or service request from a mobile communications device of the consumer; and
forwarding an authorized transaction code to the mobile communications device of the consumer to enable the consumer to enter the authorized transaction code to the self-service terminal using a manual input device thereof; and
at the self-service terminal:
assigning an active status to at least one transaction code for a period of time;
in response to entry of any code to the self-service terminal using the manual input mechanism thereof during the period of time, comparing the code entered on the manual input mechanism against the at least one transaction code assigned the active status; and
in response to a successfully matching of the code entered on the manual input mechanism to a respective transaction code assigned the active status, activating an output device of the remote terminal to provide the product or service to the consumer and removing the active status of the respective transaction code.

16. The method of claim 15 comprising forwarding the authorized transaction code from the application platform to the self-service terminal and, at the self-service terminal, assigning the active status to the authorized transaction code for a respective period of time.

17. The method of claim 15 comprising generating the authorized transaction code at the application platform.

18. The method of claim 15 comprising storing a same plurality of transaction codes at the application platform and at the self-service terminal along with data on different periods of time for which the active status is to be assigned to different groups of said transaction codes, assigning the active status to the different groups of said transaction codes at the self-service terminal according to the different periods of time, selecting a respective active code whose period of time is not about to expire from the application platform in response to the product or service request, and forwarding the respective active code to the mobile communications device of the consumer to enable the consumer to enter the respective active code to the self-service terminal using the manual input device.

19. The method of claim 15 further comprising confirming at the self-service terminal that the product or service has been provided and, in response thereto, signaling the application platform of a successful transaction to authorize billing of the consumer.
